(19) United States
(12) Patent Application Publication
(10) Pub. No.: US 2016/0363322 A1
(43) Pub. Date: Dec. 15, 2016

(54) IR-radar image generator to provide a decoy and associated method of operation

(71) Applicant: Alexander Anatoly Khmeloev, Saint Petersburg (RU)

(72) Inventor: Alexander Anatoly Khmeloev, Saint Petersburg (RU)

(21) Appl. No.: 14/304,953

(22) Filed: Jun. 15, 2014

(51) Int. Cl. F23R 3/34; B05B 5/00; F23R 3/36; F41H 11/02; F02K 3/00

(52) U.S. Cl. CPC F23R 3/346; F41H 11/02; F02K 3/00; F23R 3/36; B05B 5/001; F23R 2900/03341

(57) ABSTRACT

A method of forming a mobile combined infrared (IR)-radar decoy to protect the Navy's above-water objects by diverting IR-radar-guided missiles uses a moving jet of hot exhaust gases from an air-jet engine installed nearly horizontally on a small boat what speeds it forward. Ionization of the hot exhaust jet is accomplished by the injection of a liquid alkali metal, which when sprayed into the combustion products, burns to form an electrically conductive spray-plasma. This process occurs due to the interaction of the electrostatic Coulomb forces generated by the bound electrons on the alkali metal droplet surface with the free electrons in the vapor shells of the burning droplets. This interaction expels the free electrons into the united flame zone. The apparatus for implementing this method comprises a system for masking any visible emissions from the plasma and neutralizing the alkaline blowout into the air and water.

### RELATED APPLICATIONS

This Nonprovisional (Utility) Patent Application is a Continuation of the Provisional Patent Application No. 61/872,862 filed on Sep. 3, 2013, titled “Generator of the IR-radar image of a false target and method of operating same”.

FIELD OF INVENTION

This invention relates to a false target deployment system, which creates a set (one or more) of moving voluminous objects simulating the electromagnetic signature of real military vehicles (e.g., ships or aircraft).

### DESCRIPTION OF THE RELATED ART

Guided missile technology primarily uses two different ranges of electromagnetic waves: radar (microwaves) and infrared (IR). Radar, which is described in [1], was first introduced almost simultaneously in England and Germany during World War II to search for air targets. Then, a number of studies including Touch, G., Jones, R. V., and Curran J. et al proposed passive radar countermeasures such as chaff technologies, in which aircraft or other targets spread a cloud of small, thin pieces of aluminum or metalized glass fibers, which appear either as the primary targets on radar screens or swamp the screen with multiple returns.

Chaff dispensing systems can also be used to deflect radar-guided missiles from theft targets for the purposes of aircraft and warship self-defense.

With the exception of passive chaff technology, there are currently active radar countermeasure systems in existence that create so-called false targets or decoys.

According to reference [2], these decoys may be classified into two groups as follows:
1. Re-emission of adversary radar signals with intentional distortion such that they mimic an incident echo-signal.
2. Launch of special decoys simulating real vehicles (either aircraft or ships). These can be launched and towed using special cables behind the aircraft or ship.
   Often combinations of decoys are used to enhance the effect.

The first group of a false target radar image generator may be classified, for instance, U.S. Pat. No. 6,624,780 B1. This counter radar system comprises a receiver system for producing a digital signal that represents an incident radar signal.

Additionally, we include U.S. Pat. No. 7,598,900 B2 and German Patent No. 102010032458 A1 in this category.

The invention we describe is similar to the second group decoy, as described, e.g., in U.S. Pat. No. 3,229,291.

The second group of radar-decoy is referred to as the AN/ALE-50 system. The AN/ALE-50 Towed Decoy System is an anti-missile countermeasure decoy system developed by the U.S. Company Raytheon, Inc. to protect multiple military aircraft from radar-guided missiles, as described in [3]. This system employs an active RF decoy simulation apparatus, which can be used in airborne electronic warfare (EW) equipment. The ALE-50 system comprises a launcher and launch controller installed on the host aircraft so that the decoy can be towed by a rope behind the host aircraft, protecting it against RF-guided missiles by luring the missile toward the decoy and away from the intended aircraft. This process occurs first when the host aircraft detects a signal from an adversary radar system. The decoy intensifies the signal and re-emits it, simulating a more powerful echo signal than that of the original aircraft.

Examples of this type of towed radar-decoy system include U.S. Pat. No. 5,398,032 A and U.S. Pat. No. 4,709,235 A.

IR-guided missiles were first employed during the 1960s [4]. IR-seekers on these guided missiles were designed to track a strong source of IR radiation, which usually was the jet engine in modern military aircraft or the hot exhaust gas from a ship's engine. At that time, ideas for IR-countermeasures began to develop. IR-countermeasures are devices designed to protect aircraft from IR-missiles by confusing the missile's guidance system so that it will divert from its intended target.

A passive IR-decoy, or so-called “flare”, was developed to counter an adversary's missile guidance system to track and follow a plane or a helicopter. Flares usually consist of a pyrotechnic composition with either a hot-burning metal (e.g., magnesium) or without metals or metal-containing compounds, in which the burning temperature is equal to or hotter than the aircraft or helicopter's engine exhaust. The aim is to trick the IR-guided missile to track the heat signature from the flare rather than that from the aircraft engine.

Examples of flare-based IR countermeasures are described in U.S. Pat. No. 5,565,645 A and German Patent No. 102,004,043,991 B4.

Other decoys can create a combined IR-radar signature similar to the real vehicle, as claimed in U.S. Pat. No. 8,223,061 B2. These decoys act at respective pre-determined distances from the target vehicle and counteract the adversary missile at different ranges.

For the work we describe here, we cite U.S. Pat. No. 5,092,244 A, U.S. Pat. No. 5,424,741 A and U.S. Pat. No. 5,493,993 A.

The nearest existing device and method to the present invention that contains a prototype is described in Russian Patent No. 2,345,311.

For the decoy described in Russian Patent No. 2,345,311, the inventors first describe an inflatable mock-up of a vehicle (i.e., ship). The elastic material used to build the mock-up has an RF-reflective coating and electric heaters mounted within the material to act as IR radiation sources.

The main disadvantages and drawbacks of the prototype are its immobility, as it is only capable of being towed, and the low durability of the inflatable decoy.

### BRIEF SUMMARY OF THE INVENTION

The general objective of the present invention is to remove or obviate the disadvantages of the previous prototype.

Our invention is based on a physical phenomenon discovered by the author, which was reported in a paper [5].

The essence of the phenomenon described in this claim relies on the interaction between a layer of electrons that are bound to the surface of any piece of metal, including alkali metals, and mobile free electrons, which are associated with a flame zone. Such an interaction of the electron layers during metal burning would lead to an immense increase in the volume of vapor shells from single droplets of a burning alkali metal spray. Alkali metals have the largest surface electron layer of all metals. This invention uses the electrical inflation of the vapor shells from the burning spray droplets for the formation of connected vapor clouds, which result from the vapor interactions. These clouds exhibit high electrical conductivity and are referred to as “spray-plasma”.

Because spray-plasma jets exhibiting high electrical conductivity would reflect electromagnetic waves of certain wavelengths and also have high infrared-emission characteristics, such plasma jets may be used as a combined decoy [7].

This invention relates to mobile generators of this type of decoy employed by the Navy and implements the described process using a spray-plasma generator contained in an air-jet engine. The spray-plasma is formed inside the exhaust jet when liquid alkali metal is injected, as described in [5]. Such a decoy is contained in a small boat, with the spray-plasma generator installed on an air-jet engine that is mounted almost horizontally, at a slight angle to the horizon. The jet stream of the exhaust leaving the nozzle of the air-jet engine propels the boat forward and allows it to have a mobile combined infrared-radar signature akin to that of a large moving ship.

### BRIEF DESCRIPTION OF THE FUNDAMENTAL PHENOMENON

The invention described here is based on the fundamental electrodynamic burning mechanism for an alkali metal, specifically an alkali metal spray, which has been described in [5]. This burning mechanism involves the interaction between two electron layers near the burning surfaces of the alkali metal droplets contained in the spray.

The first electron layer, which is bound to the surface, forms as the outer part of a double electric layer (a dipole layer). The free electrons arising in the vapor shells surrounding the spray droplets form a second electron layer, i.e., a layer of free electrons. The electrostatic interactions between the two electric layers result in an immense increase in the volume of the vapor shell, i.e., the flame stand-off distance. Increasing the flame stand-off distance leads to a greater burnout time for the alkali metal droplets, as shown in [6].

Thus, a dynamic equilibrium is set up within the flame zones of the burning droplets between the internal electrical Coulomb repulsive forces of the negative ions (consisting primarily of oxygen atoms, molecules, and hydroxyl groups) and the external pressure of neutral oxygen molecules, atoms and hydroxyl groups that diffuse radially inward from the outer regions (against the outward flow of the combustion materials).

This dynamic equilibrium of forces has been previously described in [5] as an explanation for the strong electric fields existing between the two charged electron layers, also known as the vapor shells surrounding the burning droplets. The action of this electric field on the emitting atoms in the flame zone produces a so-called Stark effect.

### BRIEF DESCRIPTION OF THE DRAWINGS

For a better understanding of the claimed invention, a variant of it is described below with references to the following drawings:

FIG. 1 illustrates a side view of the combined IR-radar mobile generator decoy for naval applications during operation.

FIG. 2 shows a possible formation mechanism for the spray-plasma, which possesses high electrical conductivity.

FIG. 3 shows the estimated image size of the plasma jet at different radar wavelengths.

FIG. 4 shows the injection of liquid chlorocarbon into the peripheral area of the spray-plasma jet to reduce the apparent brightness of the burning metal and neutralize the alkaline blowout into the environment.

### DESCRIPTION OF THE PREFERRED EMBODIMENT AND ITS OPERATION

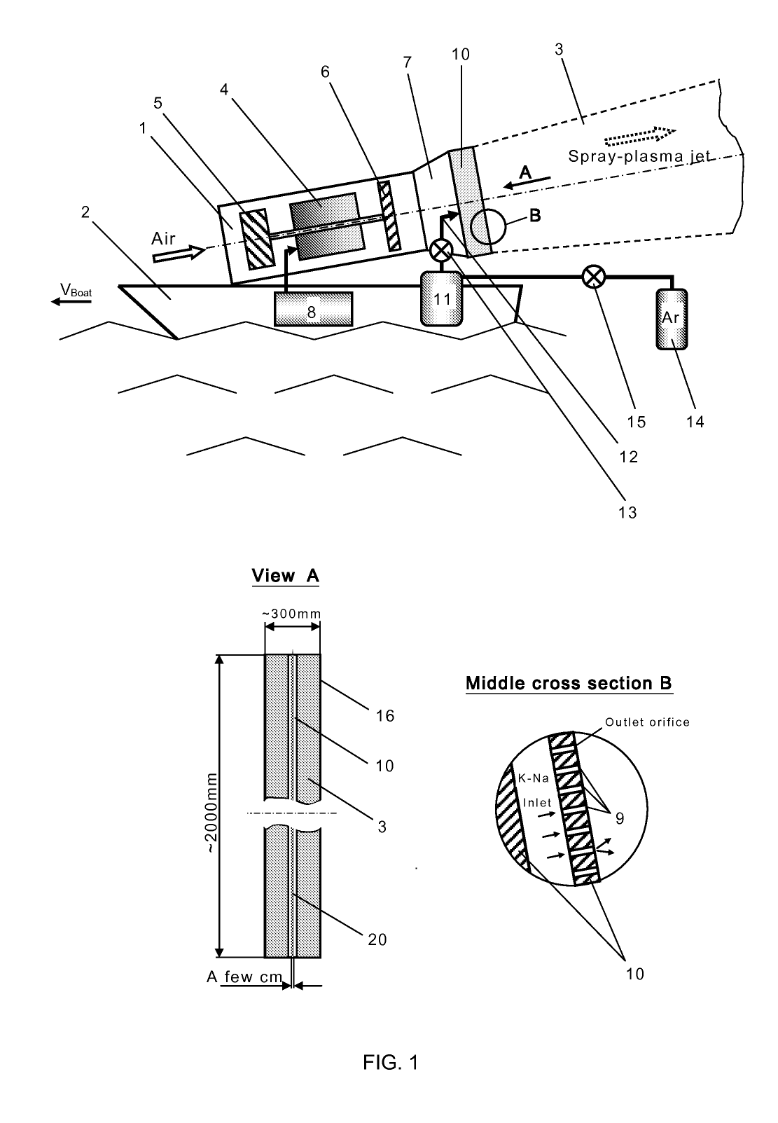

With reference to the drawings and, in particular, to FIG. 1, the IR-radar decoy generator comprises the air-jet engine, indicated at 1, which is installed almost horizontally on a small boat, indicated at 2, so that its exhaust jet, indicated at 3, both forms the plasma jet and propels the boat, indicated at 2.

A serial production air-jet engine 1 is used. The serial air-jet engine comprises the main components and systems typically seen for this type of engine: a combustion chamber, indicated at 4, a compressor for compressing intake air, indicated at 5, a turbine for driving the compressor, indicated at 6, a nozzle, indicated at 7, which accelerates the gaseous combustion products and creates the exhaust jet, indicated at 3, and the fuel feed system, indicated at 8. Power for the serial air-jet engine is selected on the basis of the specified parameters of the decoy, namely, the required length of the plasma jet, indicated at 20 (used to simulate a real ship), and the required speed of the boat 2.

The spray-plasma is formed by the cocurrent injection of liquid alkali metal into the exhaust jet, indicated at 3, and from combustion materials through the injectors, indicated at 9, which are arranged aft of a narrow pylon, indicated at 10, which itself is located in the middle vertical plane at the outlet of the nozzle, indicated at 7. The narrow pylon, indicated at 10, is aerodynamically designed to fit such a configuration to create the least amount of drag in the nozzle 7.

A supply system for liquid alkali metal comprises the following: an alkali metal container, indicated at 11, conduits for the liquid alkali metal, indicated at 12, valves for the liquid alkali metal, indicated at 13, a vessel containing compressed inert gas, such as argon, indicated at 14, to displace the liquid alkali metal, valves on the pipeline for the inert gas, indicated at 15, and the alkali metal injectors, indicated at 9. These injectors, indicated at 9, are plain orifices used to atomize the alkali metal. The liquid alkali metal may be composed of a technologically convenient K—Na-eutectic alloy (78% potassium by mass and 22% sodium by mass), which has a solidification temperature of approximately 262 K.

Because the decoy must simulate the radar cross-section of the side view of a real ship and taking into account both the cost of jet engine fuel and alkali metal, the plasma jet, indicated at 20, needs to have a flat cross section. Therefore, the nozzle, indicated at 7, for the serial jet engine, indicated at 1, should have a vertically oriented rectangular cross section with an aspect ratio of, for example, 1:7 (indicated at 16).

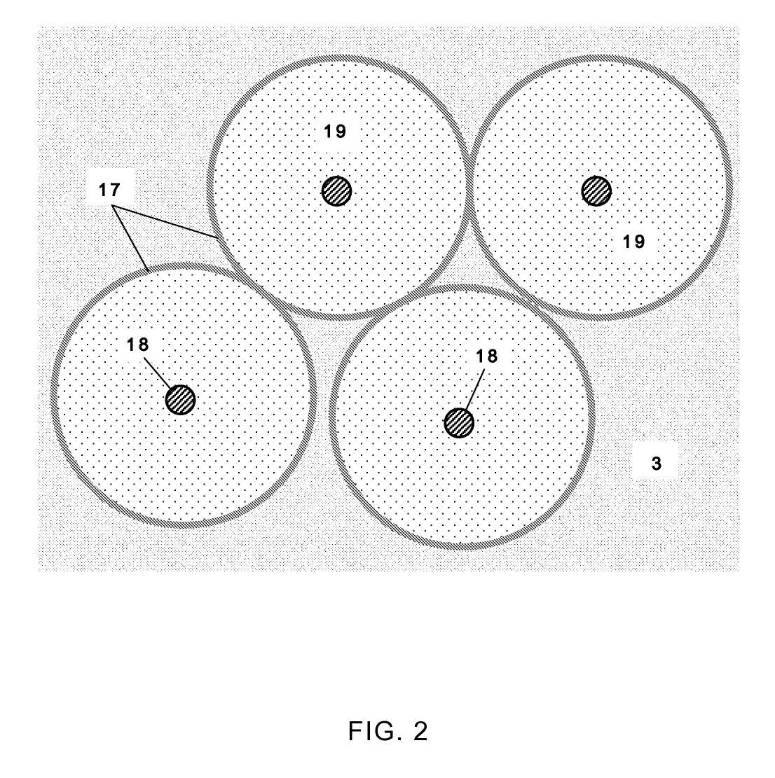

FIG. 2 shows a possible mechanism of the formation of the spray-plasma possessing high electrical conductivity, as described in [5].

The high electrical conductivity of such a spray-plasma medium can be explained through the touch of the individual flame zones, indicated at 17, of the burning metal droplets, indicated at 18, each other. Because the mobile electrons in the vapor shell, indicated at 19, of the droplet 18 are displaced by the electrostatic Coulomb forces in the roughly spheric& flame zone 17, surrounding the drop 18, this leads to a high electrical conductivity in the spray-plasma as an electrically connected medium.

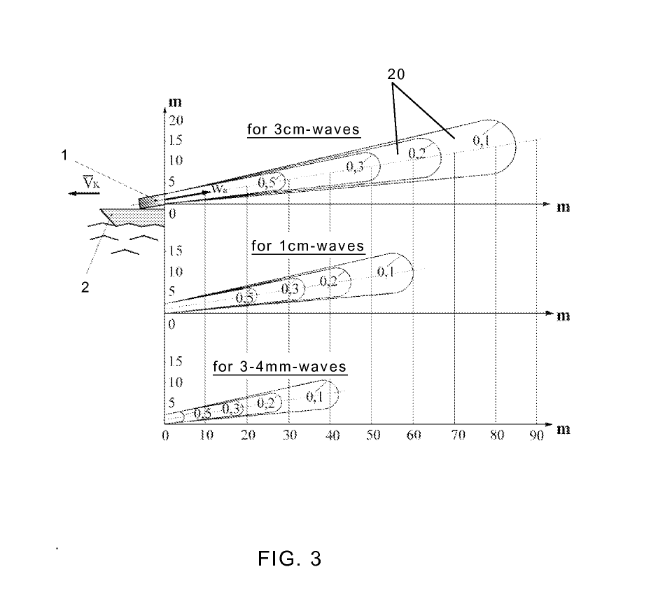

FIG. 3 shows the estimated size of the image produced by the plasma jet, indicated at 20, for different radar wavelengths and their reflection coefficients. A calculation of the length of the spray-plasma jet and the reflective properties of the radar waves was conducted based on the data given in [5-9]. As mentioned, increasing the burnout time of the alkali metal droplets is equivalent to increasing the length of the spray-plasma jet 20, up to tens of meters, perhaps reaching as much as one hundred meters.

An estimation of the parameters for the spray-plasma jet 20 has been performed for an air-jet engine, indicated at 1, which operated, in accordance with [8], using aviation kerosene at an assumed fuel mass consumption rate of 3.7 kg/s. The total flow of combustion materials was assumed to be 140 kg/s. Then the rectangular nozzle exit section is assumed to be 300 mm×2.000 mm. The pressure at the convergent (sonic) nozzle exit is assumed to be 0.1 MP, the absolute temperature at the nozzle exit is equal to 710 K, the air-fuel equivalence ratio λ in the combustion chamber, indicated at 4, for the jet engine, indicated at 1, is assumed to be λ=2.45 (for a lean mixture), and the exhaust gas velocity at the nozzle exit is equal to 580 m/s (sonic velocity).

The spray-plasma is formed in a thin (on the order of a few cm) flat layer, indicated at 20, and is composed of combustion materials 3 hi the middle plane of the nozzle 7 and atomized alkali metal. To estimate the parameters of this thin spray-plasma layer, indicated at 20, the local mass fraction of the alkali metal is assumed to be 0.1, as in [5]. Then, the required mass consumption rate for the alkali metal is equal to 3÷5 kg/s. The average droplet size was estimated to be 100 microns based on the critical Weber number.

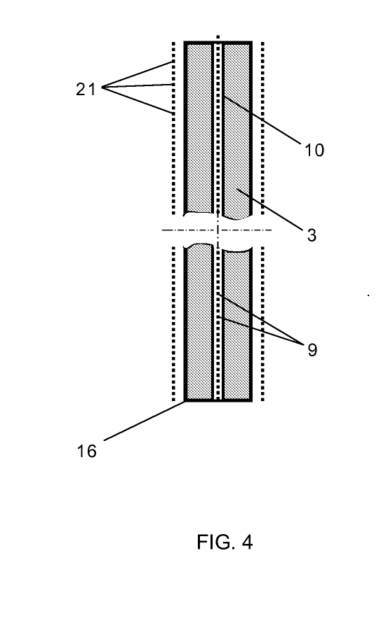

FIG. 4 shows the steps necessary to reduce the visible light emitted from burning the alkali metal and the means to neutralize the alkaline blowout into the atmosphere and water. This is accomplished using liquid chlorocarbons or titanium tetrachloride (TiCl₄) that are injected into the peripheral side area of the spray-plasma jet, indicated at 20.

As such, the chlorocarbons may be entrained in a liquid solution of hexachlorobenzene (C₆Cl₆) or carbon tetrachloride (CCl₄4) so that during the metal burning process, they can be recovered as metal chlorides and free carbon (soot), in accordance with [10]. Thus, the final products are nontoxic potassium and sodium chlorides (KCl and NaCl) and soot, which serve to form masking smoke and carbon dioxide.

The addition of chlorocarbons is performed through injectors, indicated at 21, that are arranged at the sides of the flat nozzle, indicated at 7, of the jet engine, indicated at 1, which spraying is cocurrent to the exhaust jet, indicated at 3.

The application of the decoy generator is as follows. First, the small boat, indicated at 2, is set on the sea surface. Then, the air-jet engine, indicated at 1, is started. After enemy missile startups are identified and the small boat, indicated at 2, gains speed, the valves, indicated at 13, on the liquid alkali metal line are opened so that alkali metal can be injected into the jet stream, indicated at 3, from the jet engine, indicated at 1.

If the incoming missile is successfully diverted, the spray-plasma generator is shut off. This occurs by closing the liquid alkali metal valves, indicated at 13, and shutting down the jet engine, indicated at 1. Finally, the small boat, indicated at 2, containing the jet engine, indicated at 1, is lifted back aboard the host ship for reuse.

What is claimed is:

1. A method and mobile apparatus for forming a combined IR-radar image of a false target to cause infrared-radar-guided missiles to deviate from their above-water target. The method comprises the following steps: first, the formation of a moving jet of hot exhaust gases from an air-jet engine to create a jet that is geometrically similar to the object being protected. Next, the hot exhaust jet is ionized through the injection of a liquid alkali metal into the jet, which, when atomized, heats to sufficient temperatures for self-ignition, followed by the vapor-phase burning of the metal droplets, which form an electrically conductive spray-plasma through the interactions of natural electrostatic Coulomb forces generated by the fixed electrons on the droplet surfaces with the free electrons in the droplet vapor shells, which are discarding into the united electrically connected flame zone.

2. The method according to claim 1, wherein the aforementioned spray-plasma is formed by the cocurrent injection of the liquid alkali metal into the exhaust gas jet.

3. The method according to claim 2, wherein the aforementioned injection of the liquid alkali metal is implemented in the middle of a flat gas layer a few centimeters thick at the outlet of the jet engine nozzle.

4. The method according to claim 1, wherein the aforementioned liquid alkali metal is a eutectic alloy of potassium and sodium.

5. The apparatus for the realization of the method according to claim 1 comprises the following components: a small boat, an air-jet engine, a supply system for the liquid alkali metal, and a neutralizing system.

6. The apparatus according to claim 5, wherein the aforementioned air-jet engine is installed almost horizontally on the small boat so that its exhaust jet drives the boat.

7. The apparatus according to claim 5, wherein the aforementioned air-jet engine comprises the following components and systems: a combustion chamber, a compressor for compressing the intake aft, a turbine for driving the compressor, the fuel feed system, and a nozzle for accelerating the gaseous combustion materials.

8. The apparatus according to claim 7, wherein the aforementioned nozzle has a flat shape and a rectangular cross section, which is vertically oriented.

9. The apparatus according to claim 5, wherein the aforementioned supply system for the liquid alkali metal comprises the following components: an alkali metal container, conduits for the liquid alkali metal, valves for the liquid alkali metal, a vessel with compressed inert gas to displace the liquid alkali metal, valves on the pipeline for the inert gas, and injectors for the liquid alkali metal.

10. The apparatus according to claim 5, wherein the aforementioned alkali metal injectors are arranged to the aft of a narrow pylon, which is located in the middle of the outlet of the flat shape nozzle of the jet engine.

11. The apparatus according to claim 5, wherein the aforementioned neutralizing system to neutralize the alkaline blowout into the air and water comprises the following components: a neutralizing fluid container, conduits for the neutralizing fluid, valves for the neutralizing fluid, a vessel with compressed inert gas to displace the neutralizing fluid, valves on the pipeline for the inert gas, and injectors for the neutralizing fluid.

12. The apparatus according to claim 13, wherein the aforementioned injectors for the neutralizing fluid are arranged at the sides of the flat nozzle of the jet engine.

13. The apparatus according to claim 13, wherein the aforementioned neutralizing fluid is a liquid chlorocarbon.

14. The apparatus according to claim 13, wherein the aforementioned neutralizing fluid is a liquid solution of chlorocarbon.

15. The apparatus according to claim 13, wherein the aforementioned neutralizing fluid is titanium tetrachloride (TiCl₄).
